(19) United States
(12) Patent Application Publication
(10) Pub. No.: US 2022/0284339 A1
(43) Pub. Date: Sep. 8, 2022

(54) SIMULTANEOUS MEASUREMENT OF COMMUTING OPERATORS

(71) Applicant: RIVER LANE RESEARCH LTD., Cambridge (GB)

(72) Inventors: Daochen WANG, Cambridge (GB); Thomas PARKS, Cambridge (GB); Ophelia CRAWFORD, Cambridge (GB); Earl CAMPBELL, Cambridge (GB); Steve BRIERLEY, Cambridge (GB)

(73) Assignee: RIVER LANE RESEARCH LTD., Cambridge (GB)

(21) Appl. No.: 17/634,527

(22) PCT Filed: Aug. 12, 2020
(86) PCT No.: PCT/GB2020/051915

§ 371 Date: Feb. 10, 2022

(30) Foreign Application Priority Data
Aug. 12, 2019 (GB) 1911539.3

(51) Int. Cl. G06N 10/60

(52) U.S. Cl. CPC G06N 10/60

(57) ABSTRACT

A computer-implemented method for determining a measurement value for each operator of a plurality of operators. The method comprises grouping the plurality of operators into one or more sets of mutually commuting operators, each set comprising one or more of the plurality of operators. Determining, for each set of operators: a subset of transformed operators based on the set of operators, such that the set of operators are equal to products of the subset of transformed operators; a mapping circuit based on the subset of transformed operators, wherein the mapping circuit comprises an arrangement of quantum gates configured to operate on a plurality of qubits in a quantum computer. Performing a measurement routine for each set of operators, the measurement routine comprising: preparing, using the plurality of qubits in the quantum computer, a trial state using a first arrangement of quantum gates; operating the mapping circuit on the plurality of qubits in the trial state; performing a measurement on each qubit of the plurality of qubits, to obtain a qubit measurement value for each qubit.

This disclosure relates to determining an energy level. In particular this disclosure relates to a method for determining an energy level of a physical system. Additionally, this disclosure relates to determining measurement outcomes of mutually commuting operators using a quantum computer.

### BACKGROUND

It is extremely useful in many areas of technology to be able to determine the possible eigenstates and energies of a physical system such as a molecule or atom. Determining how the energy is likely to change as the system is perturbed allows many molecular properties to be derived. For example, by solving the Schrödinger equation associated with the molecular electronic structure Hamiltonian for a number of nuclear geometries, it is possible to construct the potential energy surface (PES) of a molecular system. Knowledge of the PES is hugely important, particularly in the field of chemistry, as it allows scientists to determine, among other things, rates of reactions.

Determining excited states is required to determine optical spectra, as well as other charge and energy transfer processes in photovoltaic materials. Characterisation of excited states also allows a better understanding of many chemical reactions, such as those that involve photodissociation. Moreover, classical methods such as density functional theory are often unable to determine excited states, even for materials where ground state energy calculations are possible.

Many current methods of obtaining information about the eigenstates and energies of physical systems rely on classical computers, which use complicated algorithms to simulate the physical system. However, such methods often require an unmanageable amount of computing resources or do not return solutions to sufficient accuracy. It is possible to simulate systems much more efficiently on a quantum computer than is possible on a classical computer, and there has been progress in the experimental development of quantum computers using a variety of architectures. Small devices based on trapped-ions or superconducting systems are now available with a clear roadmap to large-scale implementation.

There are known methods of finding an energy level of a physical system using a quantum computer. For example, the Variational Quantum Eigensolver (VQE) method can be used to estimate the energy levels of a physical system to a specified accuracy, given knowledge of the Hamiltonian of the system.

Known methods such as the VQE require many repeated trial state preparations and many repeated measurements on the trial state to be performed on a quantum computer, meaning it can take a long time and a lot of processing power to obtain useful results. It is therefore desirable to be able to reduce the number of repeated trial state preparations and measurements when determining an energy level of a physical system.

The present invention seeks to address these and other disadvantages encountered in the prior art by providing an improved method of determining an energy level of a physical system in which measurements of multiple operators used to determine the energy level can be obtained simultaneously.

### SUMMARY

According to an aspect of the disclosure, there is provided a method for determining measurement outcome values of each operator of a plurality of operators, the method comprising: grouping the plurality of operators into one or more sets, each set comprising one or more of the plurality of operators; determining, for each set of operators: a subset of transformed operators based on the set of operators; a mapping circuit based on the subset of transformed operators, a post-measurement processing routine based on the subset of transformed operators; performing a measurement routine for each set of operators, the measurement routine comprising: preparing, using a plurality of qubits on the quantum computer, a trial state using a first arrangement of quantum gates; operating the mapping circuit on the plurality of qubits in the trial state; performing a measurement on each qubit of the plurality of qubits, to obtain a qubit measurement value for each qubit; and applying the post-measurement processing routine to the qubit measurement values to transform the qubit measurement values into operator measurement values for each of the operators in the set of operators.

Examples of the use of this method include determining the energy level of a physical system. Accordingly, disclosed herein is a method for determining an estimate of an energy expectation of a physical system using a quantum computer. The energy expectation is described by the summation of the expectation values of a plurality of operators, the method comprising: determining a measurement value for each operator of the plurality of operators, the determination comprising: grouping the plurality of operators into one or more sets, each set comprising one or more of the plurality of operators; determining, for each set of operators: a subset of transformed operators based on the set of operators; a mapping circuit based on the subset of transformed operators, a post-measurement processing routine based on the subset of transformed operators. Determining the measurement outcome for each operator of the plurality of operators further comprises performing a measurement routine for each set of operators, the measurement routine comprising: preparing, using a plurality of qubits on the quantum computer, a trial state using a first arrangement of quantum gates; operating the mapping circuit on the plurality of qubits in the trial state; performing a measurement on each qubit of the plurality of qubits, to obtain a qubit measurement value for each qubit; and applying the post-measurement processing routine to the qubit measurement values to transform the qubit measurement values into operator measurement values for each of the operators in the set of operators. The method further comprises determining the estimate of an energy expectation of a physical system based on at least the determined operator measurement values for each operator in each set.

Optionally, determining the subset of transformed operators, determining the mapping circuit, and determining the post-measurement processing routine is carried out using a classical computer, and wherein the classical computer further carries out the step of applying the post-measurement processing routine to the qubit measurement values to transform the qubit measurement values into operator measurement values for each of the operators in the set of operators. This is advantageous over prior methods as it allows the process of determining the operator measurement values from the qubit measurement values to be determined classically instead of using additional gates in the mapping circuit. This therefore reduces the computational requirements on the quantum computer and allows a simpler mapping circuit with a few qubit gates as possible to be used.

The steps of preparing the trial state, operating the mapping circuit, and performing a measurement on each qubit may be carried out using a quantum computer.

Optionally, the measurement routine is performed a plurality of times for each set to obtain a corresponding plurality of operator measurement values for each operator in each set. The method may further comprise determining an expectation value of each operator in each set based on an average of the corresponding plurality of operator measurement values. Optionally, determining the estimate of the energy expectation comprises a summation of the expectation values for each operator in each set.

Optionally, the mapping circuit comprises at least one multi-qubit gate configured to act on at least two of the plurality of qubits. This is advantageous over prior methods as it allows the sets of operators to be grouped into groups of generally commuting operators, which allows groups with large numbers of operators and thus a large number of operator measurement values can be obtained simultaneously using the methods disclosed herein.

Optionally, the mapping circuit comprises one or more multi-qubit gates, wherein the number of multi-qubit gates is proportional to the number of the plurality of qubits, and wherein the proportionality has an upper bound of the number of the plurality of qubits multiplied by the number of independent operators in the set of operators, wherein each operator in the set of operators can be constructed from the one or more independent operators

In some embodiments, the mapping circuit comprises one or more single-qubit gates configured to apply rotations to each qubit of the plurality of qubits.

In some embodiments, each operator in a set generally commutes with every other operator in the set. This is advantageous over prior methods as it allows for larger groupings of operators, meaning more operator measurement values can be obtained simultaneously using the methods disclosed herein.

Optionally, determining a subset of transformed operators comprises: determining one or more independent operators of the set of operators, wherein each operator in the set of operators can be constructed from the one or more independent operators; and transforming the one or more independent operators into the subset of transformed operators.

Optionally, transforming the one or more independent operators into the subset of transformed operators comprises: determining whether the number of independent operators matches the number of the plurality of qubits; and responsive to determining that the number of independent operators is less than the number of the plurality of qubits: constructing one or more new transformed operators to be added to the subset of transformed operators, such that the number of transformed operators matches the number of qubits.

Optionally, the qubit measurement values represent measurement values of the subset of transformed operators. The post-measurement processing routine is then used to transform the transformed operator measurement values into operator measurement values. This is advantageous over prior methods as it allows the process of determining the operator measurement values from the qubit measurement values to be determined classically instead of using additional gates in the mapping circuit. This therefore reduces the computational requirements on the quantum computer and allows a simpler mapping circuit with a few qubit gates as possible to be used.

According to a further aspect of the disclosure, there is provided computer readable medium comprising instructions which, when executed by a processor, cause the processor to perform any one of the disclosed methods.

According to another aspect of the disclosure, there is provided an apparatus comprising a classical computer and a quantum computer configured to carry out any one of the disclosed methods.

### BRIEF DESCRIPTION OF DRAWINGS

Specific embodiments are described below by way of example only and with reference to the accompanying drawings in which:

FIG. 1 depicts a Variational Quantum Eigensolver (VQE) method for determining the energy level of a physical system according to the state of the art

FIG. 2a depicts a measurement routine for determining measurement outcomes for a plurality of Pauli operators according to known methods.

FIG. 2b depicts a measurement routine for determining measurement outcomes for a plurality of Pauli operators according to some embodiments.

FIG. 3 illustrates how embodiments of the present disclosure may be incorporated into a VQE framework for determining an energy level of a physical system

FIG. 4 is an illustrative example of a mapping circuit according to one specific embodiment.

FIG. 5 is a flowchart illustrating a method according to embodiments of the present disclosure.

FIG. 6 illustrates a block diagram of one implementation of a computing device according to some embodiments.

### DETAILED DESCRIPTION OF DRAWINGS

Reference is made herein to equations numbered (1) to (31) which are provided in appendix A at the end of the description.

In hybrid quantum-classical algorithms such as the Variational Quantum Eigensolver (VQE), the problem of determining energy levels of a physical system is specified by the problem Hamiltonian, H. This Hamiltonian is specific to a physical system such as an atom or molecule, and describes the energy levels of that physical system as described below. The problem Hamiltonian is split into a sum of so-called Pauli operators as per equation (1). The coefficients aᵢ are computed by a classical computer and the Pauli terms, Pᵢ have the property that their expectation values for any given trial state are possible to estimate on a quantum computer. The total expectation value of the Hamiltonian, <H>, is estimated by measuring the expectation value of each Pauli operator Pᵢ in turn and computing their sum, weighted by the coefficients, on a classical computer.

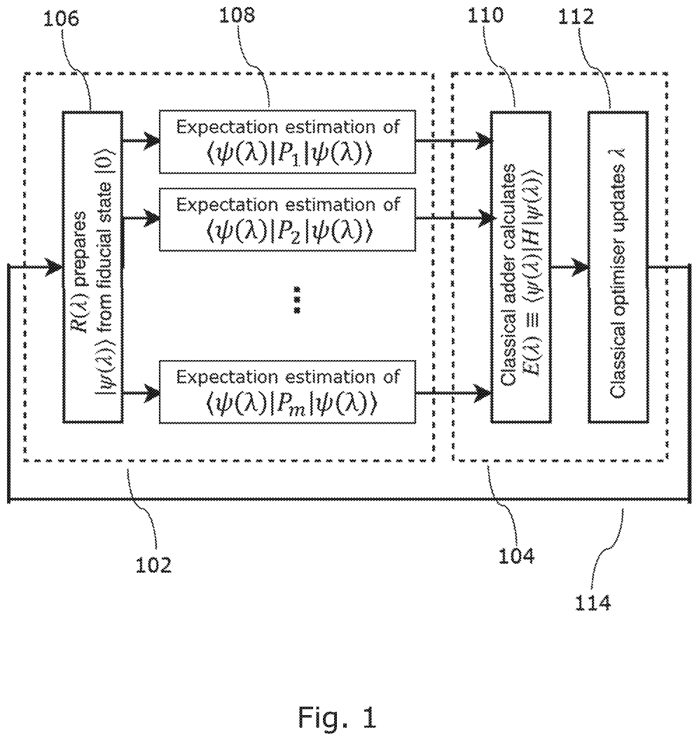

Reference is now made to FIG. 1, which depicts a Variational Quantum Eigensolver (VQE) method for determining the energy level of a physical system according to the state of the art. Dashed box 102 depicts those parts of the method which are performed using a quantum computer, using quantum circuits. Dashed box 104 depicts those parts of the method which are performed using a classical computer, using classical circuits. Arrows between dashed boxes 102 and 104 depict the interface between the quantum and classical computers.

As will be understood by the skilled person, the energy states of a physical system may be described using a Hamiltonian operator, which comprises a summation of a plurality of Pauli operators. The standard VQE method can be used to determine an energy level of a Hamiltonian H of a physical system using a quantum expectation estimation routine (depicted by boxes 108) together with a classical optimizer 112. The classical optimizer adjusts the trial state wavefunctions |ψ(λ) [symbol] , depending on a parameter λ. For a given normalized |ψ(λ) [symbol] , it is possible to evaluate energy:

E(λ)= [symbol] ψ(λ)|H|ψ(λ) [symbol] =Σaᵢ [symbol] ψ(λ)|Pᵢ|ψ(λ)

[symbol]

To describe the standard VQE in more detail, the idea is to first write the Hamiltonian operator, H, as a finite sum H=ΣaᵢPᵢ where aᵢ are complex coefficients and Pᵢ are Pauli operators. Each aᵢPᵢ can be described as a summand. The number m of summands is assumed to be polynomial in the size of the system as is the case for the electronic Hamiltonian of quantum chemistry.

To evaluate the energy state of the physical system, knowledge of the Hamiltonian is used to determine an ansatz trial state |ψ(λ) [symbol] which can be prepared using a plurality of qubits on a quantum computer. This ansatz trial state has an energy E(λ), dependent on a parameter λ. The trial state is prepared in the quantum processor, and an arrangement of quantum gates, otherwise referred to as quantum circuits, are used to determine the expectation values of each summand one at a time. Given the expectation value estimates, a classical computer 104 is used to determine the weighted sum based on the corresponding complex coefficient aᵢ for each Pauli operator. This summation produces an estimate and/or a determination of the trial state energy. Finally, a classical optimiser such as Nelder-Mead is used to optimise the function E(λ) with respect to λ by controlling a preparation circuit:

R(λ):|0 [symbol] →|ψ(λ)

[symbol]

where |0 [symbol] is a starting state of the qubits. The variational principle (VP) justifies the entire VQE procedure when finding the ground state: writing Eₘᵢₙ for the ground state eigenvalue of H, VP states that E(λ)≥Eₘᵢₙ with equality if and only if |ψ(λ)> is the ground state. Similarly, local minima in the E(λ) curve are representative of other energy levels/states of the physical system. Thus it is possible to determine an estimate of an energy level of a physical system described by a Hamiltonian using VQE methods.

In the typical VQE process, a preparation circuit, R, comprised within the quantum computer, is used to prepare an initial trial state |ψ(λ) [symbol] . The preparation of the initial trial state is shown at box 106 of FIG. 1. The preparation circuit R is a specific arrangement of quantum gates determined by the parameter λ which is used to prepare the trial state on a plurality of qubits in the quantum computer.

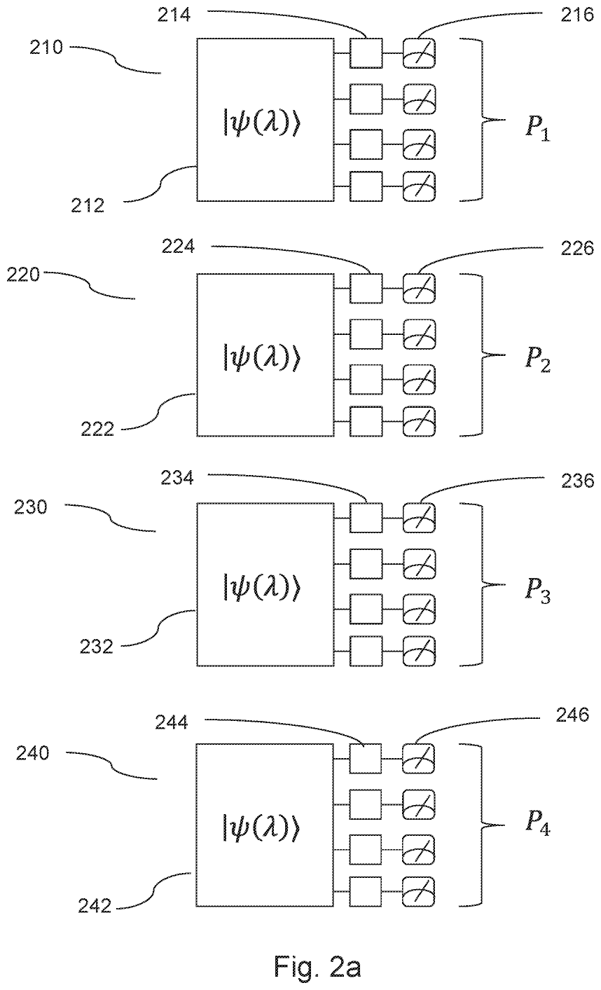

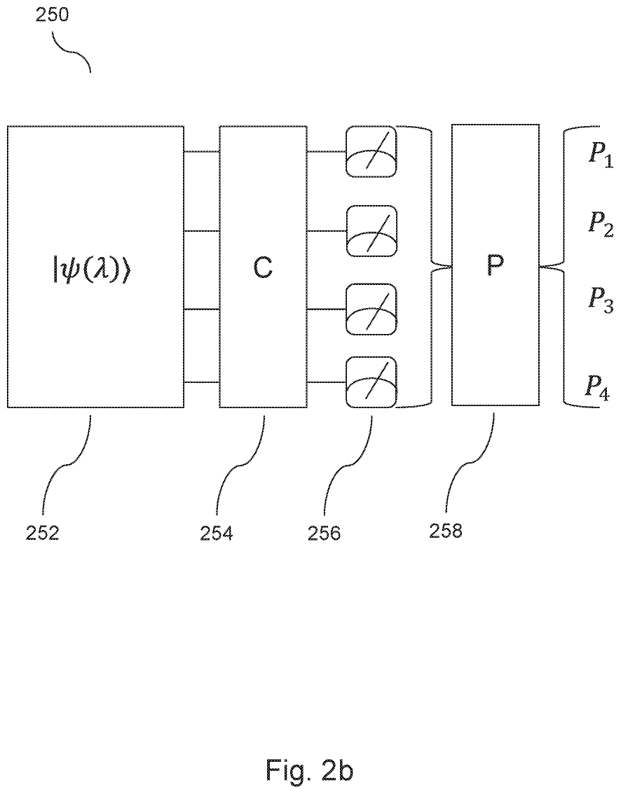

The expectation value of each Pauli operator term in the Hamiltonian can then be estimated for the given trial state. This determination is shown at blocks 108 of FIG. 2. In other words, to determine an energy eigenvalue of a Hamiltonian with m summands, the quantum computing device makes measurements of: P₁; P₂; . . . Pₘ on the trial state.

These measurements are then communicated to a classical computing device, depicted by dashed box 104 in FIG. 1, which computes the expectation values: [symbol] ψ(λ)|P₁|ψ(λ) [symbol] ; [symbol] ψ(λ)|P₂|ψ(λ) [symbol] ; . . . [symbol] ψ(λ)|Pₘ|ψ(λ) [symbol] . As will be understood by the skilled person, each measurement Pᵢ may be directly obtained using a simple circuit with circuit depth D=O(1). To determine the expectation value of each Pauli operator, a plurality of measurements are performed on the trial state to obtain a plurality of measurement outcomes for that Pauli operator. In other words, the same quantum circuit is applied to the qubits in a given trial state a plurality of times and the qubits are then measured to provide a measurement outcome value. The measurement outcome values form a statistical distribution from which the expectation value of the Pauli operator can be obtained, for example by taking an average value from the plurality of measurement outcome values.

Having computed the expectation value of each Pauli operator, the classical computing device determines the weighted sum of the expectation value of each Pauli operator, weighted by the corresponding complex coefficient aᵢ, to find the energy value of the Hamiltonian for the initial trial state. Based on this value, the classical computer 104 updates the parameter λ at box 112, which allows the constructions of a new trial state. The quantum computer is instructed to prepare the new trial state, and the whole process is repeated until an optimisation procedure is satisfied that the desired energy level has been determined to the specified accuracy. The measurement process is repeated N=O(1/ϵ²) times for each Pauli operator in order to attain precision within c of the expectation. Thus the number of repetitions scales polynomially with the required accuracy. Each repetition requires the trial state |ψ(λ) [symbol] to be prepared on the quantum computer using preparation circuit R, since the qubits in the trial state are measured each time, thus collapsing the state of the qubits. Therefore, in the known VQE method according to the state of the art, N state preparations are required to determine the expectation value of a single Pauli operator. It follows that for a Hamiltonian with m Pauli operator terms, known methods require N×m state preparations on the quantum computer to determine an energy expectation for a trial state |ψ(λ) [symbol] , thus requiring a large number of state preparations and measurement operations. Known methods are therefore limited in that a large number of calculations are required, thus requiring a longer processing time and longer operation of the quantum computer, in order to obtain useful results.

However, new superconducting, trapped ion and proposed networked quantum computer architectures allow for parallel measurement and readout of qubits. The methods of present disclosure exploit the ability to perform simultaneous measurements for more than one Pauli operator in order to reduce the total number of state preparations and measurements (and therefore the runtime) when determining energy expectation for trial states.

As discussed in more detail below, terms in the Hamiltonian are grouped together according to a specific property, and then measurements can be obtained simultaneously for every term in a group. After the usual state preparation circuit to prepare the trial state |ψ(λ) [symbol] , methods of the present disclosure perform a novel rotation or mapping circuit specifically constructed for the group such that after a single measurement of all n qubits, a measurement outcome of every term in the group can be determined from the measurements on the n qubits.

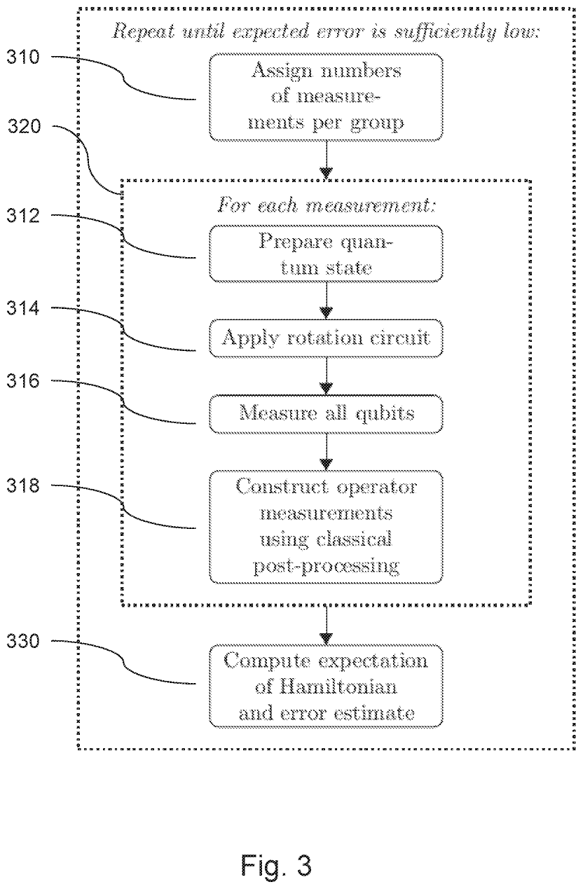

FIG. 3 illustrates how methods of the present disclosure may be incorporated into a VQE framework for determining an energy level of a physical system. Specifically, FIG. 3 depicts method steps that the equivalent to boxes 106, 108 and 110 in the VQE method depicted in FIG. 1, wherein measurements of a plurality of operators in a group can be obtained simultaneously, instead of one-at-a-time. Operators are grouped together into sets of operators based on certain properties of the operators as discussed in more detail below.

At step 310, the number of measurements, N, per group or set is determined. As described above, N represents the number of repeated state preparations and corresponding measurements that are performed in order to obtain a distribution of measurement values from which the expectation values of every operator in the group can be obtained. In other words, the number of measurements per group, N, represents the number of repetitions of the steps in dashed box 320.

Dashed box 320 comprises the method steps of the present disclosure which are used to simultaneously obtain measurement outcomes for every operator in the group. At step 312, a trial state is prepared using a plurality of qubits on a quantum computer, analogous to step 106 in FIG. 1. At step 314, a rotation circuit or mapping circuit is applied to the plurality of qubits prepared in the quantum state. The rotation circuit is discussed in more detail below and is constructed using a specific arrangement of quantum gates depending on the group of operators. At step 316, each qubit that was prepared in the quantum state and to which the rotation circuit was applied is measured to obtain a measurement value. The measurement value will be a +1 or a −1. Thus, at step 316, a plurality of qubit measurements are obtained. The qubit measurements are then input into a post-measurement routine at step 318 (otherwise referred to as classical post-processing) which transform the qubit measurements into measurement outcomes for each operator in the set. The post-measurement routine comprises determining the one or more products of any of the one or more of the qubit measurements in order to determine the measurements of each the operators in the set. The specific products of specific qubit measurements are determined based on the set of operators itself and this is discussed in more detail below.

The process identified in dashed box 320 is repeated N times for each group/set (N being determined at step 310, which may be the same for each set of operators or may be specific to a given set of operators) to obtain N measurements for each operator in each set. From the N measurements of each operator, the expectation value of the operator can be determined by taking an average value of the N measurements. Thus an expectation value of every operator in a set can be obtained from N repetitions of the box 320 for that set.

At step 330, an expectation value of the Hamiltonian is determined by summing the expectation values of each term in the Hamiltonian (each weighted operator expectation value), wherein the expectation value of the operators that make up the Hamiltonian are determined at step 320. In other words, an estimate of the energy expectation of the physical system represented by the Hamiltonian is determined based on the expectation values of the operators. Additionally, an estimate of the error associated with the Hamiltonian expectation estimate may also be determined. Furthermore, the output of step 330 may be input into a classical optimizer as in step 112 of FIG. 1 in order to update the trial state in a wider VQE framework.

A high-level illustration of the methods of the present disclosure and a comparison to known approaches is depicted in FIGS. 2a and 2b to illustrate the advantage provided over known methods. FIG. 2a illustrates the measurement routine of boxes 108 in FIG. 1 according to known methods. The measurement routine is used to determine a measurement outcome for Pauli operators of the Hamiltonian of the physical system. The measurement routines are used within VQE (as boxes 108) in order to determine the energy level of a physical system.

FIG. 2a depicts a measurement routine for determining measurement outcomes for a plurality of Pauli operators according to known methods. FIG. 2a depicts 4 different measurement routines 210, 220, 230 and 240 for determining a measurement outcome for each of P₁, P₂, P₃, and P₄ respectively. In this known method, each of 210, 220, 230 and 240 is performed separately to determine the respective measurement outcomes one at a time. This is because each measurement routine comprises a state preparation (212, 222, 232, 242) on qubits in the quantum computer, which are then operated on using quantum gates (214, 224, 234, 244), before the qubits are measured (216, 226, 236, 246). The measurement outcomes of all the qubits can be used to obtain a measurement of a single Pauli operator. This process must be repeated for each of Pauli operators P₁, P₂, P₃, and P₄, using the same state preparation and using quantum gates that are constructed based on the specific Pauli operator.

In the particular examples illustrated in FIGS. 2a and 2b, the process requires 4 qubits (indicated by the 4 qubit wires and 4 measurement outcomes, one measurement for each qubit). However, it would be appreciated by the skilled person that in some examples, any number of qubits may be used as is necessary for the relevant Pauli operators.

FIG. 2b depicts a measurement routine for determining measurement outcomes for a plurality of Pauli operators according to methods of the present disclosure. In stark contrast to the methods depicted in FIG. 2a, FIG. 2b allows the measurement outcomes of more than one operator to be determined simultaneously using a new rotation circuit C. FIG. 2b depicts the state preparation 252 which prepares the qubits in the quantum computer into the trial state, similar to steps 212, 222, 232 and 242 in FIG. 2a. A new circuit C is then used to operate on the qubits in the trial state at 254. The new circuit C comprises an arrangement of quantum gates including multi-qubit gates and is discussed in more detail below. Following the operation of the circuit C on the qubits in the trial state, the qubits are measured at 256. The measurement outcomes of the qubits are then processed using a new post-measurement routine P (258) to simultaneously determine the measurements of each of Pauli operators P₁, P₂, P₃, and P₄. A discussion of the hardware used for state preparation and operation of quantum circuits on qubits is discussed below. Therefore, in stark contrast to the known method of FIG. 2a, methods of the present disclosure allow measurements of more than one Pauli operator to be obtained using a single state preparation and a single set of circuit and measurement operations.

The new mapping circuit and new post-measurement routine therefore enable a single trial state preparation and set of qubit measurements in order to simultaneously obtain information on more than one Pauli operator. In more detail, the disclosed methods enable simultaneous measurement of all Pauli operators in a group, wherein each Pauli operator in the group has a specific property as discussed in more detail below.

Methods of the present disclosure, such as the method 250 depicted in FIG. 2b, can be used within the framework of VQE but are able to determine energy expectations in a considerably shorter time than the known VQE methods. Specifically, the method of FIG. 2b can be used to replace boxes 108 in FIG. 1 (in the known VQE method) in order to obtain expectation value estimates of multiple Pauli operators at the same time. Importantly, the methods of the present disclosure are able to determine measurements for a number of Pauli operators in the Hamiltonian simultaneously, as opposed to performing a measurement routine for each Pauli operator individually.

Grouping the Operators

As discussed above, methods of the present disclosure can be used to simultaneously determine a measurement outcome for each operator in a group or set of operators. The operators are grouped according to a specific property: the operators in a group are mutually commuting. For any group of mutually commuting operators, it is possible to obtain measurements of each simultaneously by applying a mapping circuit on the quantum computer and carrying out some classical post-processing. The mapping circuit and classical post-processing are described in more detail below.

Generally Commuting Operators

For a problem defined on n qubits, there are 4ⁿ−1 possible Pauli operators (excluding the identity term) that could make up the Hamiltonian. Each Pauli operator commutes with 2²ⁿ⁻¹−2 others. The maximum number of mutually commuting operators is 2ⁿ−1, although only n of these will be independent (the remainder can be constructed from the products of those in the independent set). The number of qubits on which a problem is defined represents the number of qubits upon which a Pauli operator may operate, which may be equivalent to a number of terms that make up the Pauli operator. The number of qubits may be at least in part dictated by the specific physical system that is described by the Hamiltonian, and may also be at least in part dictated by how the problem is represented on the quantum computer.

Typically, a chemical Hamiltonian has only O(n⁴) terms. One method of sorting these terms into groups of mutually commuting operators is to take each operator in turn, check if it can be placed in an already existing group and, if not, start a new group. Performing this method for every operator in the Hamiltonian allows every Pauli operator to be placed in a group, wherein every Pauli operator in a group mutually commutes with every other Pauli operator in that same group.

In more detail, for a problem defined on n qubits each operator in the Hamiltonian may have up to n sub-terms, each sub term being a Pauli matrix, X, Y, or Z, or may alternatively be the identity matrix, I. Methods of the present disclosure apply to groups of Pauli operators that generally commute.

As an example of generally commuting operators, take the following two Pauli operators:

P₁=X₁Z₂I₃Y₄

P₂=Y₁Z₂I₃X₄

If P₁ and P₂ commute, then the products P₁P₂ and P₂P₁ are equal.

The product P₁P₂, as would be appreciated by a skilled person would be:

P₁P₂=X₁Y₁×Z₂Z₂×I₃I₃×Y₄X₄=iZ₁×1×1×−iZ₄=−i×i×Z₁Z₄=Z₁Z₄

As it would be known that the square of any Pauli matrix is 1, and XY=−YX=iZ.

The product P₂P₁, as would be appreciated by a skilled person would be:

P₂P₁=Y₁X₁×Z₂Z₂×I₃I₃×X₄Y₄=−iZ₁×1×1×iZ₄=−i×i×Z₁Z₄=Z₁Z₄

Thus P₁P₂=P₂P₁ and so P₁ and P₂ commute, even though corresponding terms in the same position in each operator may not commute (e.g. the first terms X₁ and Y₁ as well as the fourth terms Y₄ and X₄ do not commute with each other as XY does not equal YX).

It would be appreciated by the skilled person that there is a clear distinction here over Pauli operators that locally commute. For Pauli operators that locally commute, each term in an operator must commute with the corresponding term in the same position in another operator. In other words, locally commuting operators are more restricted in that they require operators to have the same Pauli matrix or the identity matrix in each position in the string of sub-terms. It is clear that the examples of generally commuting operators P₁ and P₂ above do not locally commute since the first terms and fourth terms are not commuting (they are different Pauli matrices).

It would be understood that groups of locally commuting operators are more limited than groups of generally commuting operators. The property of general commutation enables large numbers of operators to be grouped together. Methods of the present disclosure apply a novel mapping circuit based on the generally commuting group of operators to the qubits in the trial state in order to determine a measurement outcome for each operator in the group. Thus, by grouping the operators into groups of generally commuting operators, it is possible to have larger groups and therefore obtain more simultaneous measurements at once.

Expectations of Operators in Standard Form

For a group of operators in a particular form, the mapping circuit required in order to make measurements of all the operators simultaneously is known, and no classical post-processing is required. This form is as follows. For n Pauli operators defined on n qubits, these operators can be written as \tilde{P}ᵢ for 1≤i≤n. The notation Oᵢⱼ can be used to denote the jth Pauli matrix (i.e. the matrix that acts on qubit j) of the ith Pauli operator then Oᵢᵢ=X for all i, and Oᵢⱼ=Oⱼᵢ=Z or I for all i,j with j≠i.

It can be shown that the expectation value for a group of operators in this form can be provided by equation (2) in appendix A. U is the same for all i, and U comprises an application of a control-Z gate to every pair of qubits i, j for which Oᵢⱼ=Z, followed by a Hadamard gate on every qubit. Therefore, in order to get a measurement of each of the operators \tilde{P}ᵢ, the rotation given by U is applied and then every qubit is measured.

An example set of operators, defined on four qubits, of this standard form is provided in equation (3) in appendix A. The specific rotation circuit or ‘mapping’ circuit for this specific group of generally commuting operators that is applied to the qubits is provided in equation (4), where Hᵢ is a Hadamard gate applied to qubit i and cZᵢⱼ is a control-Z gate applied to qubits i and j.

It is possible to perform further one qubit rotations that result in a subset of transformed operators based on the original set of operators. The transformed operators are in the standard form with the possible addition of single-qubit rotations applied to one or more of the qubits. Measurements on the qubits after applying the further single-qubit rotations and the control-Z and Hadamard gates described above provide measurements of the subset of transformed operators. The original operators can be obtained from products of the transformed operators, and so measurements of the original operators can be obtained using a post-measurement processing routine that determines measurements of the original operators from products of the qubit measurements (equivalently products of the transformed operator measurements). Methods of the present disclosure are used to manipulate or transform a general group of generally commuting operators into the specific form described above (hereinafter referred to as the ‘standard form’). Such manipulations or transformations consist of one-qubit rotations as described in more detail below and taking products of the original operators, which corresponds to classical post-processing, otherwise referred to as post-measurement processing. In other words, methods of the present disclosure comprise transforming a set of operators into a subset of transformed operators, wherein the subset of transformed operators are a subset of operators in the standard form and may optionally have further single-qubit rotations applied to each qubit. The original set of generally commuting operators are then equal to products of the transformed operators. Thus, measurements of the original set of operators can be obtained from products of the measurements of the transformed operators.

The rotation or mapping circuit that is applied is determined based on the transformation between the transformed operators and the operators in standard form, and the form of the operators in standard form. In other words, the mapping circuit comprises single-qubit rotations which represent the transformation between the subset of transformed operators and the operators in standard form, and further comprise two-qubit control-Z gates and Hadamard gates as described above. The number and operation of the control-Z gates depends on the form of the resultant transformed operators (or, equivalently, the form of the operators in standard form). A post-measurement routine is also determined which transforms qubit measurements into measurement values for the original set of generally commuting operators.

Therefore, in some embodiments of the present disclosure, the method comprises manipulating a group of generally commuting operators into a subset of transformed operators, wherein the subset of transformed operators are based on a group of operators in the standard form and may have further single-qubit rotations applied to each qubit. However, it would be appreciated by the skilled person that the step of transforming the group of generally commuting operators into a specific form may be omitted, for example, if the group of generally commuting operators is already in the specific form required by the method.

Furthermore, it would be appreciated that the specific form of the operators and the corresponding mapping circuit may not be exactly as described above but may instead require other specific properties of the group of operators. The corresponding mapping circuit may equally require any other suitable multi-qubit gate to be applied to a certain pair or set of qubits.

Calculating the Mapping Circuit

As described above, the group of generally commuting operators are manipulated into a transformed subset of operators in a specific form, and the corresponding mapping circuit can be determined based on the subset of transformed operators. The following discussion provides one specific method, with the addition of a second alternative for part of the manipulation, according to the present disclosure for manipulating the operators and determining the specific mapping circuit based on the transformed operators, and is not intended to be limiting.

We note that, in order to simplify the method and rotation circuit, any qubits on which all operators locally commute can be dealt with separately. In what follows, it is assumed any such qubits have been removed from the system.

Binary Framework

Methods of the present disclosure employ the binary framework for representing Pauli matrices of the Pauli operators of the Hamiltonian. In this framework, the Pauli matrices are represented using the following notation:

I=σ₀₀ [symbol] 00;

X=σ₀₁ [symbol] 01;

Y=σ₁₁ [symbol] 11;

Z=σ₁₀ [symbol] 10.

An n-qubit Pauli operator is defined as a 2n-dimensional binary vector σᵤ_{₁}ᵥ_{₁} . . . σᵤ_{ₙ}ᵥ_{ₙ}=(u₁ . . . uₙv₁ . . . vₙ). Given M n-qubit Pauli operators in a group of generally commuting Pauli operators, a binary matrix S of size 2n×M can be written to represent all of the Pauli operators. It will be appreciated that in this framework, the two Pauli operators represented by the binary vectors a and b commute iff a^{T} P b=0, where

$$P = ( \begin{matrix}0 & I \\ I & 0\end{matrix} ) .$$

Based on the specific form of the operators as discussed above, methods of the present disclosure involve finding the matrix S in the form of equation (5) in appendix A. In this form, Q⁻¹ is a 2n×2n matrix, S′ is a 2n×n matrix, representing a group of operators of the standard form described above, and R⁻¹ is a n×M matrix. The −1 superscripts are purely notational—in particular, R⁻¹ is not necessarily invertible.

The matrix S′ representing a group of operators of the standard form discussed above has the structure of a matrix as provided in equation (7), where A is an n×n symmetric matrix with diagonal elements equal to 0 and I is the n×n identity matrix. The matrix Q⁻¹ contains information about the one-qubit rotations required to transform between the group of transformed operators and the operators in standard form. The matrix R⁻¹ contains information about how measurements of the original operators can be constructed from measurements of the transformed operators. In other words, the matrix R⁻¹ represents the post-measurement routine which allows measurements of the original operators to be determined from products of the qubit measurements (or equivalently, from products of measurements of the transformed operators).

In some embodiments of the present disclosure, the method may comprise finding K independent Pauli operators from which all the other M operators in the group can be constructed. In some embodiments, this comprises performing Gauss-Jordan elimination to transform S into reduced row echelon form, and the matrix S can then be written in the form provided in equation (8), where \tilde{S} is a 2n×K-dimensional matrix consisting of the columns of S which match the pivot columns in its reduced row echelon form, and R₀⁻¹ is an K×M-dimensional matrix formed of the non-zero rows of the reduced row echelon form of S. The columns of \tilde{S} give the independent Pauli operators desired and R₀⁻¹ contains the details of how the other operators in the group of M operators can be constructed from these.

\tilde{S} can then be manipulated into the form

$$( \begin{matrix}Z ′ \\ X ′\end{matrix} )$$

as discussed below, where X′ is an invertible n×n matrix. From this, it is apparent that equation (9) in appendix A may apply, where

Z′ X′⁻¹ is symmetric as

$${( \begin{matrix}{Z}^{′} {X}^{′ - 1} \\ 1\end{matrix} )}^{T} P ( \begin{matrix}{Z}^{′} {X}^{′ - 1} \\ I\end{matrix} ) = 0 ;$$

however, it may have non-zero diagonal elements. These can be removed through application of the one-qubit rotation

$$( \begin{matrix}1 & 1 \\ 0 & 1\end{matrix} )$$

in order to provide S′, the required matrix of the form given in equation (7).

As discussed above, the matrix \tilde{S} can be manipulated into the form

$$( \begin{matrix}Z ′ \\ X ′\end{matrix} ) .$$

The exact method for this manipulation depends on whether \tilde{S} has rank K=n or K<n. In other words, the method for this manipulation depends on whether the number of independent terms in the group of generally commuting operators is equal to or less than the number of qubits.

In both cases (K=n and K<n), Gaussian elimination is applied on the lower half of the \tilde{S} matrix in order to find its pivot rows. Having done so, matrix Q₁ is applied to the left of \tilde{S}, wherein the matrix Q₁ is constructed by applying the rotation

$$( \begin{matrix}0 & 1 \\ 1 & 0\end{matrix} )$$

to all qubits which do not correspond to one of the pivot rows of the lower half of \tilde{S}. The lower half of the new matrix Q₁\tilde{S} has rank K.

If K=n (i.e. the number of independent Pauli operators in the mutually commuting group of Pauli operators is equal to the number of qubits on which the problem is defined), the lower half is therefore an invertible n×n matrix and we define the matrix R₁ to be this inverse and evaluate Q₁\tilde{S}R₁. The lower half of Q₁\tilde{S}R₁ is the n×n identity matrix, and the upper half is a symmetric n×n matrix.

In order to get the matrix into the desired form, as in equation (7), the matrix Q₂ is constructed, which applies the rotation

$$( \begin{matrix}1 & 1 \\ 0 & 1\end{matrix} )$$

to any qubits which have a 1 on the equivalent diagonal element in the upper half of Q₁\tilde{S}R₁. The matrix S′ representing a set of operators in standard form which is defined as S′=Q₂Q₁\tilde{S}R₁ (as defined in equation (10) in appendix A), has the desired form as given in equation (7). Therefore, \tilde{S}=Q₁⁻¹Q₂⁻¹S′R₁⁻¹ as provided in equation (11).

Using equation (8) it can be seen that S=Q₁⁻¹Q₂⁻¹S′R₁⁻¹R₀⁻¹ as provided in equation (12).

From this, it can be seen that the matrix Q⁻¹ which contains information about the one-qubit rotations required to transform between the transformed operators and operators in standard form is provided as in equation (13) in appendix A (Q⁻¹=Q₁⁻¹Q₂⁻¹). Further, the matrix R⁻¹ which contains information about how measurements of the original operators can be constructed from measurements of the transformed operators (i.e. R⁻¹ contains information on the classical post processing) is provided as in equation (14) to be R⁻¹=R₁⁻¹R₀⁻¹).

If K<n (i.e. the number of independent Pauli operators in the mutually commuting group of Pauli operators is less than the number of qubits on which the problem is defined), the lower half of Q₁\tilde{S} contains an invertible K×K submatrix. Performing Gaussian elimination again on this new lower half shows which rows are in this invertible submatrix, which is defined to be R₁⁻¹. The lower half of the state Q₁\tilde{S}R₁ contains the K×K identity matrix within a selection of its rows.

If K<n, the method comprises constructing n-K further independent commuting Pauli operators so that the whole set of operators can be transformed into the ‘standard form’ as discussed above. From the form the operators are now in, it is easy to construct the further required operators. The whole system including the further operators is placed in a new matrix S_{full}. The ith operator in the existing K has either an X or a Y on the qubit which corresponds to the ith row in the identity matrix. The remaining operators can have only a Z in these same locations. There are no limitations on the Pauli matrices on the qubits which do not correspond to a row of the identity matrix. The additional operators are required to each have one X on one of the rows which are not in the identity matrix. Each X may commute or anticommute with the term in the same position in the already existing operators. For each operator with which it anticommutes, a Z is placed in the same positions as the operator's X or Y. It is known that no other operator has anything but a Z here, and so the new operator now commutes with all the existing operators.

The new matrix containing all of the independent Pauli operators including the additionally constructed operators is therefore obtained. This can be related back to \tilde{S} through equation (15) as provided in appendix A, where R₂⁻¹ is an n×K matrix of the form

$$( \begin{matrix}I \\ 0\end{matrix} ) ,$$

with 1 being the K×K identity matrix and 0 the (n-K)×K zero matrix. The lower half of S_{full} is full rank and so the matrix R₃ is defined to be the inverse of this lower half. Therefore, S_{full}R₃ has lower half equal to the identity. In order to form a group of operators of the desired ‘standard form’, the rotation matrix

$$( \begin{matrix}1 & 1 \\ 0 & 1\end{matrix} )$$

is applied to any qubit with a 1 on its diagonal in the top half. Q₂ contains these rotations. The product Q₂ S_{full} R₃ therefore has the form shown in equation (7) and so S′=Q₂S_{full}R₃ as in equation (16).

Using equations (8) and (15), it is possible to see that S=Q₁⁻¹Q₂⁻¹S′R₃⁻¹R₂⁻¹R₁⁻¹R₀⁻¹ as provided in equation (17). Therefore, the matrix Q⁻¹ which contains information about the one-qubit rotations required to transform between the transformed operators and the operators in standard form is provided as in equation (18) in appendix A (Q⁻¹=Q₁⁻¹Q₂⁻¹). Further, the matrix R⁻¹ which contains information about how measurements of the original operators can be constructed from measurements of the transformed operators (i.e. R⁻¹ contains information on the classical post processing) is provided as in equation (19) to be R⁻¹=R₃⁻¹R₂⁻¹R₁⁻¹R₀⁻¹).

Constructing the Mapping Circuit

The above discussion describes how a group of mutually commuting Pauli operators are transformed into the ‘standard form’ using various matrix manipulations, depending on whether the number of independent terms in the group is equal to or less than the number of qubits on which the problem is defined. Methods disclosed herein determine a subset of transformed operators (Q⁻¹S′) from the original group of mutually commuting Pauli operators. The methods determine matrix Q⁻¹ which provides the information on how to transform between the transformed subset of operators and the operators in standard form (S′), as well as matrix R⁻¹ which provides information on how to obtain measurements of the original group of operators from measurements of the transformed group of operators.

Measurements of the subset of transformed operators are obtained using a quantum computer and a mapping circuit that is constructed in the quantum computer hardware, for example using a quantum computer and quantum gates as described below. The mapping circuit comprises an arrangement of quantum gates that operate on one or more qubits in the quantum computer. The mapping circuit applies single-qubit rotations to the qubits, which represent the single-qubit transformations that are described by the matrix Q⁻¹. In other words, the mapping circuit comprises single-qubit quantum gates that operate on the qubits, which represent the transformations between the transformed operators and operators in the standard form. The mapping circuit further comprises two-qubit quantum gates, in this example specifically control-Z, which operate on certain qubits depending on the exact form of the operators in standard form. Specifically, the mapping circuit comprises a control-Z gate that operates on qubits i, j for which Oᵢⱼ=Z in the matrix O of operators in standard form.

As another example, blocks of control-X or CNOT gates can be used if some minor changes to the post-measurement processing routine are made. More specifically, the upper left K×K sub-matrix of S′, which is denoted by E, is symmetric. It would therefore be appreciated that E can be Cholesky decomposed as E=M₀^{t}M₀+L where M₀ is invertible, L is diagonal, and the t superscript indicates the transpose of a matrix. Then E can be eliminated by CNOT gates, corresponding to M₀, and one-qubit gates. This leaves M₀ in the upper-left K×K sub-matrix of the lower half of S′ which can be eliminated using the post-measurement processing routine. Further one-qubit gates can transform the upper half of S′ to a matrix F that is block-off-diagonal except for 1s on the diagonal. This matrix F is then susceptible to a block-Cholesky decomposition into three matrices M₁^{t}D₁M₁ where M₁ is an n×n matrix that is all zero except for 1s on the diagonal and its upper right K×(n-K) corner. F can be reduced to D₁M₁ by a second round of CNOT gates corresponding to M₁. This is efficient due to the sparsity structure of M₁. S′ now has D₁M₁ in its upper half and M₁ in its lower half. The M₁ in both halves can be eliminated using post-processing leaving D₁ in the upper half and the n×n identity matrix on the lower half. D₁ is block diagonal with an upper left K×K submatrix G and a lower right (n-K)×(n-K) identity. Cholesky decomposing G allows us to eliminate it in the same way E is eliminated. This corresponds to a third and final round of CNOT gates, one-qubit gates and post-processing.

The discussion below provides details of how the Q⁻¹ matrix obtained above is converted into a quantum circuit (the mapping circuit) comprising an arrangement of quantum gates. The Q⁻¹ matrix describes how the transformed operators and operators in standard form are related. The corresponding circuit applies the single-qubit rotations that transform between the transformed operators and the operators in standard form

It would be understood that the specific quantum gates used in the mapping circuit desired will depend on the specific quantum hardware used to obtain measurements of the transformed operators. In this specific and non-limiting example, control-Z gates and three types of one-qubit rotation gates are used.

There are two possible types of single qubit rotations given in the matrix Q⁻¹:
1.

$$( \begin{matrix}0 & 1 \\ 1 & 0\end{matrix} )$$

which maps X to Z, Y to itself and Z to X;
2.

$$( \begin{matrix}1 & 1 \\ 0 & 1\end{matrix} )$$

which maps X to Y, Y to X and Z to itself.

When applying gates to perform the above rotations, it is not possible to perform the first two rotations exactly as described—a factor of −1 is required in front of one of the terms. Since there are no Y terms in the final group of operators (owing to the specific ‘standard form’ of the operators as discussed above), the −1 factor can be put with this term. The gates required to perform the desired rotations are:
1.

$${R}_{y} ( \frac{π}{2} )$$

followed by Rₓ(π) which maps X to Z, −Y to Y and Z to X;
2.

$${R}_{z} ( - \frac{π}{2} )$$

which maps X to Y, −Y to X and Z to itself.

A control-Z gate is then applied wherever there is an off-diagonal Z in the operators in standard form. Finally, a

$${R}_{y} ( - \frac{π}{2} )$$

(the equivalent of a Hadamard gate) is applied to every qubit in order to measure in the X-basis. In alternative examples, other types of two-qubit gate may be applied in place of the control-Z gate, or alternatively a multi-qubit gate that acts on two or more qubits may be used. As a result of the methods used herein to determine the subset of transformed operators, the number of multi-qubit gates in the resultant mapping gate is proportional to the number of qubits and the number of independent operators from the original set of operators. Specifically, the number of multi-qubit gates in the mapping circuit has an upper bound that is proportional to the product of the number of qubits, n and the number of independent operators, K.

As would be understood by a skilled person, any multi-qubit gate may be performed by a sequence of one- and two-qubit gates and, conversely, a sequence of one- and two-qubit gates can be written in terms of a multi-qubit gate. As such the terms multi-qubit gate and two-qubit gate should be understood as referring to the property that the effect of the gate cannot be calculated by looking at the effect of the gate on one qubit in isolation

Constructing the Measurements

As discussed above, the matrix R⁻¹ contains the information about how measurements of the original Pauli operators can be constructed from Z measurements of each qubit, having applied the mapping circuit described above. After the mapping circuit as described above has been applied to each qubit, the qubit is measured. The measurement outcomes for each qubit is a value of either a +1 or −1 and represent measurements of the transformed operators. Therefore the matrix R⁻¹ contains information about how the measurements of the transformed operators can be transformed into measurement outcome values for the original operators. The jth column of R⁻¹ contains the required information for the jth Pauli operator. A measurement of the jth Pauli operator can be made by taking the product of the measurements of each qubit i for which R⁻¹ᵢⱼ=1. As would be understood by the skilled person, the process of transforming measurements of the transformed operators into measurements of the original operators comprises classical transformations. Specifically, in this particular example, this process involves multiplication of two or more real numbers. Thus it would be understood that this transformation routine is a classical routine that is performed on a classical computer, instead of a quantum computer.

It would be understood by a person skilled in the art that the binary framework does not allow for information about the phases of the Pauli operators to be retained. In order to work them out, we apply Q to S′ to ‘undo’ the one-qubit rotations, then take the products indicated by the R matrix, keeping track of the phase factors. The products of two Pauli operators are provided by equations (20) to (25) in appendix A.

### Worked Example

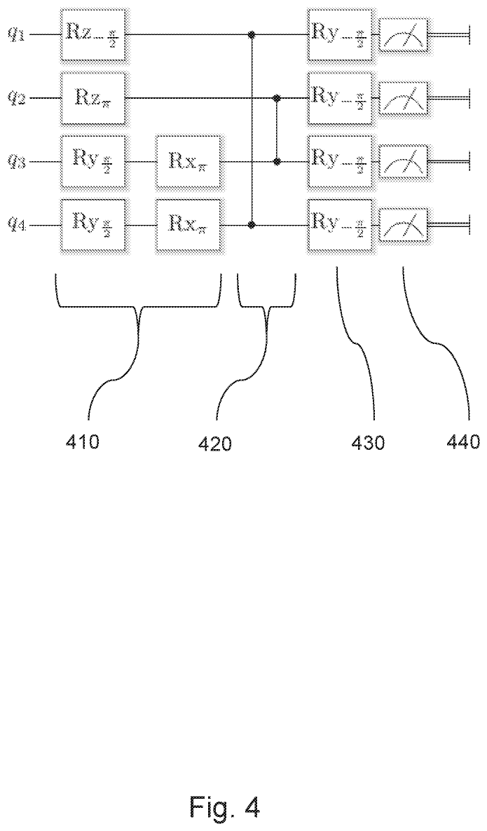

A worked example of the methods described above is provided in appendix B below. Specifically, the worked example provides one specific and non-limiting example of the methods of: transforming a group of mutually commuting operators into a subset of transformed operators, wherein the transformed operators are in the ‘standard form’ with the possible addition of one-qubit rotations as described above; determining a mapping circuit to be constructed on a quantum computer that corresponds to transforming the transformed operators to computational basis measurements; and determining the post-measurement routine to transform the measurements of the transformed operators into measurement values for the original operators. FIG. 4 is a schematic of the resultant mapping circuit for this specific worked example. Items 410 represent the single-qubit gates that represent a transformation between the transformed operators and the operators in standard form. Items 420 represent the two-qubit control-Z gates that are applied between qubits (q₁,q₄), and (q₂,q₃). Items 430 represent the Hadamard gate equivalent that is applied to every qubit in order to measure the qubits in the X basis. The Hadamard gate equivalent at 430 is a single-qubit gate that applies a Y rotation of

$$- \frac{π}{2}$$

radians. Items 440 represent the measurements on each of the qubits. Following the measurements on the qubits, the post-measurement routine as provided in equation (24) in Appendix B is applied to the measurements to transform them into measurement outcomes for the original operators in equations (26)-(31).

Method

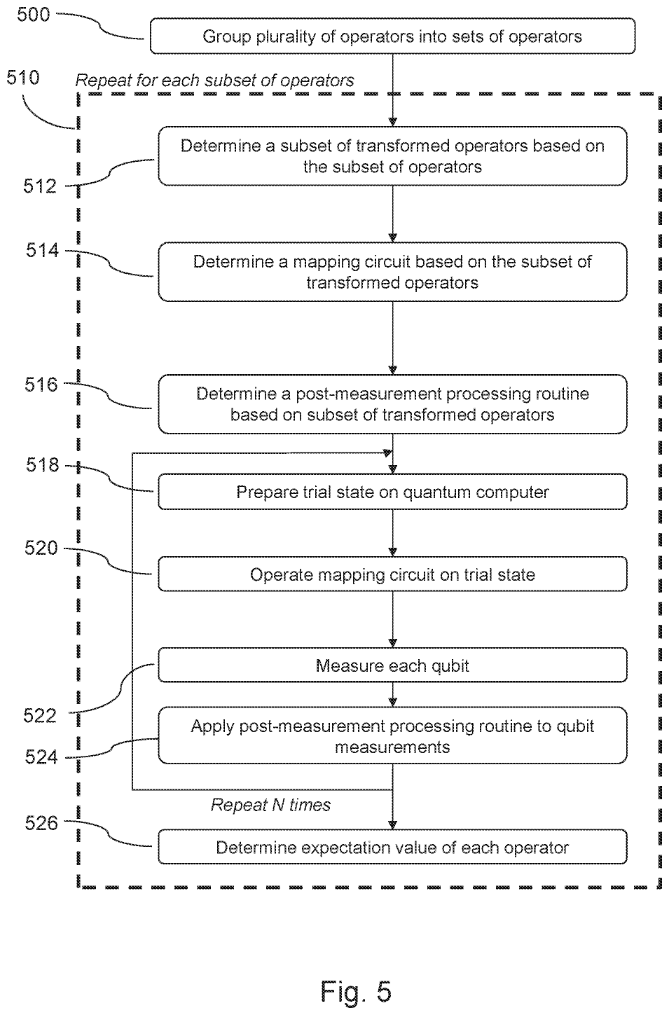

FIG. 5 is a flowchart depicting a method according to the present disclosure. The method illustrated is suitable for determining measurement outcomes, also referred to as operator measurement values, of a plurality of operators at the same time using a quantum computer. In other words, the method is suitable for simultaneously obtaining measurement values of a plurality of operators. This is done by preparing a trial state using a plurality of qubits, applying a mapping circuit to the qubits in the trial state, and subsequently measuring the qubits to obtain qubit measurement values. The method further comprises performing a post-measurement processing routine to transform the qubit measurement values into measurement outcomes, or operator measurement values, for each of the plurality of operators. Optionally, the method further comprises determining the expectation value of each of the plurality of operators, by repeating a routine on a quantum computer in order to obtain a plurality of measurement outcomes for each operator. The expectation value of each operator may then be determined based on the plurality of measurement outcomes for that operator. The specific steps of the method are described in more detail below.

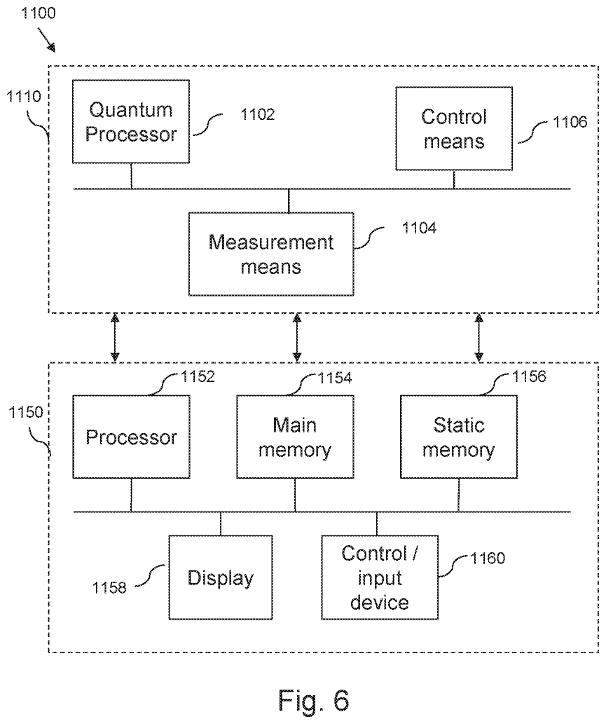

At step 500, a plurality of operators are grouped into separate sets of operators. Each set comprises one or more of the plurality of operators, and the operators are grouped such that each operator in a given set commutes with every other operator in the same set. In more detail, the operators are grouped such that the operators in a given set mutually and generally commute with each other. In embodiments, the operation of grouping the operators into sets of generally commuting operators comprises using one of a number of possible sorting algorithms. The sorting algorithm may be executed on a classical computer, such as classical computer 1150 depicted in FIG. 6. In more detail, the grouping of the operators at step 500 may be executed by processor 1152 on the classical computer. The resulting groupings may be stored in main memory 1154 or static memory 1156 on the classical computer.

After the operators have been grouped into sets of generally commuting operators, the method proceeds onto subroutine 510. Subroutine 510 comprises steps 512-526 which are performed for each of the sets determined at step 500. Subroutine 510 is used to simultaneously determine measurement outcomes and optionally expectation values of each operator in a given set. The subroutine is repeated for each set to determine measurement outcomes and optionally expectation values for each operator in the plurality of operators. Steps 512-526 are discussed in detail below with reference to one particular set, however the steps may be repeated in an identical fashion for each set.

Subroutine 510 starts with step 512. At step 512, a transformed subset of operators is determined based on the original set of generally commuting operators. The step of determining the transformed subset of operators may comprise obtaining the independent operators in the set. In particular, in a set of m operators, there may exist K independent operators (K<m) from which the remaining m-K operators can be constructed. Thus it is possible to obtain measurements of the K independent operators and construct the measurements of the remaining m-K operators in the set from the measurements of the K independent operators. Once the independent operators in the set have been obtained, a group of operators in ‘standard form’ as described above with reference to equation (2) are determined, and a subset of transformed operators are determined based on the group of operators in the standard form. Determining the subset of transformed operators comprises determining a transformation that uses single-qubit rotations to transform the group of operators in the standard form into the subset of transformed operators. The transformation may involve the mathematical techniques such as the matrix manipulations described above (see the ‘Binary Framework’ section above). Additionally, if K<n, where n is the number of qubits in the system, the step of determining the transformed operators may additionally comprise constructing n-K additional operators which also commute with every other operator. This step may be executed on a classical computer, such as classical computer 1150 depicted in FIG. 6. In more detail, determining the subset of transformed operators may be executed by processor 1152 on the classical computer (i.e. the mathematical manipulations may be performed using the processor 1152). The resulting subset of transformed operators is stored in main memory 1154 or static memory 1156 on the classical computer.

At step 514, a mapping circuit to be prepared on a quantum computer is determined based on the subset of transformed operators determined at step 512. This may involve determining the form and structure of the mapping circuit. The mapping circuit is determined based on the transformation techniques used to transform the set of transformed operators into computational basis measurements that can be made on a quantum computer (see the ‘constructing the mapping circuit’ section above’). For example, the mapping circuit comprises single-qubit rotations that transform between the transformed operators and the operators in standard form, as well as two-qubit gates such as control-Z which operate on specific qubits depending on the operators in standard form. In other words, the specific form of the mapping circuit is based on the subset of transformed operators. This step may be determined on a classical computer, for example using processor 1152. Specifically, the classical computer may be used to determine the specific type and arrangement of single-qubit and two-qubit gates in the mapping circuit. This information may then be stored in main memory 1154 or static memory 1156, before being sent to a quantum computer 1110 which constructs the mapping circuit. In particular, the information may be sent to the control means in the quantum computer, which controls the quantum processor to prepare the mapping circuit using physical quantum gates. The skilled person would be aware of how various single-qubit and two-qubit quantum gates may be physically implemented using various quantum computer architectures.

At step 516, the post-measurement routine for transforming qubit measurements into measurements of the original set of operators is determined based on the subset of transformed operators determined at step 512. Steps 514 and 516 may be performed simultaneously or sequentially. Specifically, either step 514 or 516 may be performed first, or both steps may be performed at the same time. The post-measurement routine comprises classical mathematical manipulations that convert qubit measurements into operator measurements. In particular, the post-measurement routine may comprise taking the products of two or more of the qubit measurements to determine measurements for each of the original operators in the set. The specific products are determined based on the subset of transformed operators. Specific details of how the post-measurement routine is determined are provided in the ‘constructing the measurements’ section above. Determining the post-measurement processing routine may be performed by the classical processor 1152 on the classical computer 1150. The instructions for the routine may then be stored in the main memory or static memory on the classical computer 1150.

At step 518, a trial state is prepared on a quantum computer. The trial state may be based on a specific parameter (λ) that is updated in an iterative fashion in a VQE framework. Alternatively, the trial state may be prepared based on knowledge of a physical system for which an energy level is to be determined. The trial state is prepared on a plurality of qubits. Specifically, the trial state is prepared on a number of qubits which matches the number of qubits on which the problem is defined (i.e. the number of qubits that matches the maximum number of terms in the Pauli operators), and the trial state is prepared on the qubits using an arrangement of quantum gates, such as single-qubit gates or two-qubit gates, or other multi-qubit gates. The specific type and arrangement of quantum gates used to prepare the trial state depend on the trial state itself. The skilled person would be aware of how to prepare a specific trial state on a plurality of qubits using an arrangement of quantum gates.

At step 520, the mapping circuit determined at step 514 and constructed on the quantum computer is applied to the qubits that have been prepared in the trial state at step 518. Specifically, the single-qubit gates and two-qubit gates in the mapping circuit are applied to the qubits in the trial state at the quantum processor. An example mapping circuit for a specific subset of transformed operators is depicted in FIG. 4.

At step 522, after the mapping circuit has been applied to each qubit in the trial state, each qubit is measured, for example using a measurement means 1104 on a quantum computer. This gives qubit measurements for each qubit, each of which will be a value of +1 or −1. The qubit measurements are indicative of measurement outcomes of the subset of transformed operators. The skilled person would be aware of how to measure qubits on a quantum computer, using any suitable measurement means available to him or her. The qubit measurements may then be sent to the classical computer for readout or further processing as described below.

After the qubits have been measured at step 522, the post-measurement routine determined at step 516 is applied to the qubit measurements, in order to transform the qubit measurements from: measurement outcomes for the subset of transformed operators, to: measurement outcomes for each of the operators in the original set of operators. As discussed above, the post-measurement processing routine may comprise taking the products of two or more of the qubit measurements in order to determine the measurements of the original operators in the set. Alternatively, for one or more of the operators in the set, it may be the case that the measurement of that operator is given by a single qubit measurement, i.e. there is a one-to-one mapping from a qubit measurement value to an operator measurement operator. An example of a post-measurement processing routine is provided in the worked example in appendix B. Specifically, the matrix provided at (49) provides details of how the original operator measurements are constructed from the qubit measurements for this specific worked example. It can be seen that some operator measurements are determined from the product of multiple qubit measurements, whilst others are simply readouts of single qubit measurements. It would be appreciated that the post-measurement processing routine may be performed on the classical computer, since it involves multiplication of real numbers. Thus classical processor 1152 may be used to apply the post-measurement processing routine to the qubit measurements in order to determine the corresponding operator measurements, which may in turn be stored in a memory at the classical computer.

The resultant operator measurements may then be read out at the classical computer, for example by displaying the results on a display 1158. At this point, the method may be terminated for the specific set for which steps 512-524 have been performed. The steps 512-514 may then be repeated for every other set of operators, to determine measurement outcomes for every operator of the plurality of operators.

Alternatively, instead of terminating the method at step 524 for each set, the method may comprise a plurality of repetitions of steps 518-524 in order to obtain a plurality of measurement outcomes for each operator in the set. The method may then proceed to step 526, wherein an expectation value for each operator in the set is determined. In some implementations of the method, the expectation value for each operator is determined by taking the average of the measurement outcomes for that operator, which may be determined using the classical computer. Steps 512-526 may then be repeated for every set to obtain expectation values for every operator of the plurality of operators. The energy expectation of a physical system can then be determined by taking a weighted sum of the expectation values of every operator. The expectation values may be determined using the classical processor 1152 on the classical computer 1150.

The design of the methods of the present disclosure are motivated by technical considerations of the internal functioning of a quantum computer. In particular, in view of the constraints of modern day quantum computers, such as the time taken and computational expense required in preparing trial states on a number of qubits as well as operating on and measuring those qubits, the disclosed methods are able to exploit the quantum properties of qubits and quantum gates constructed on a quantum computer in order to obtain measurements of Pauli operators simultaneously. It would be appreciated that, in the context of determining an energy level of a physical system, performing simultaneous measurements for a number of different Pauli operators in a Hamiltonian enables the ultimate number of state preparations, operations, and measurements to be reduced. It is therefore apparent that in considering the functioning and constraints of quantum computers, the present methods provide a distinct advantage over known methods in which operators are measured one-at-a-time. Appendix C ‘Minimising Error’ provides further information on how the number of state preparations is reduced by grouping the operators into groups of generally commuting operators, compared to a case where the operators are not grouped, and measurements are determined individually.

Further advantages over known methods are provided by at least the use of the post-measurement processing routine to transform qubit measurements into measurements of the operators. In particular, the use of a classical computer to carry out the post-measurement processing routine allows the requirements of the quantum computer to be reduced, by reducing the number of quantum gates in the mapping circuit. The inventors have given careful thought as to how best to reduce the number of quantum gates in the mapping circuit, making the required quantum circuit less complex and therefore less difficult to implement. The methods of the present disclosure employ specific techniques to obtain transformed operators related in a specific manner to operators of a specific ‘standard’ form. While in theory additional gates could be used to achieve what the present method achieves, functionality has been pushed to the classical computer which performs a post-measurement processing routine, thus reducing the requirements on the quantum computer and making the best use of the processing power of both the quantum computer and the classical computer. In more detail, the post-measurement processing routine performs the function of transforming qubit measurement values into operator measurement values. The qubit measurement values represent measurement values of the transformed operators, and so the post processing routine transforms the transformed operator measurement values into original operator measurement values. This function can in theory be performed using additional quantum gates in the mapping circuit, however, by specifically considering the internal functioning of the quantum and classical computers when designing the method, greater efficiencies and processing speed can be achieved by reducing the number of quantum gates and exploiting classical processing power for this specific function. It is therefore clear that, in view of the difficulties and constraints in implementing large quantum circuits on a quantum computer, the disclosed methods provide a comparatively simpler method for obtaining measurements of operators that is much easier to implement on a quantum computer.

Resource Requirements

The methods described herein require many matrix manipulations, all carried out on a classical computer, the most complex of which is Gauss-Jordan elimination. For a square matrix of size D, this process has complexity O(D³). The largest matrix upon which we perform such elimination is of size 2n×Mₘₐₓ, where Mₘₐₓ is the maximum number of terms in a group. The complexity of performing Gauss-Jordan elimination on such a matrix is O(nMₘₐₓ²).

Considering the number of two-qubit gates in the mapping circuit, in order to measure a group of operators of the form of the ‘standard form’, a two-qubit gate, specifically a control-Z gate or equivalent implementation, is required for every off-diagonal Z matrix present. The maximum number is therefore ½ n(n−1), which is O(n²). However, when K≠n, the maximum number of two-qubit gates required is in fact ½ n(n−1)−½(n-K)(n-K−1)=nK−½ K(K+1) which is O(nK), which is similar in size but may be less than O(n²).

This is because of the way in the additional operators are constructed to make the matrix S_{full} full-rank—there will never be an off-diagonal Z between two of the additional operators, which is how the −½(n-K)(n-K−1) term arises.

Apparatus

FIG. 6 illustrates a block diagram of one implementation of a computing device 1100 within which a set of instructions for causing the computing device to perform any one or more of the methodologies of the present disclosure may be executed. While only a single computing device is illustrated, the term “computing device” shall also be taken to include any collection of machines (e.g., computers) that individually or jointly execute a set (or multiple sets) of instructions to perform any one or more of the methodologies discussed herein. The computing device 1100 comprises a quantum computing system 1110 and a classical computing system 1150. The quantum computing system 1110 is in communication with classical computing system 1150. The classical computing system is arranged to instruct the quantum computing system to prepare quantum states, and to perform measurements on those quantum states, according to instructions stored in memory.

The quantum computing system 1110 comprises a quantum processor 1102, which in turn comprises at least two qubits and at least one coupler capable of coupling the qubits. The qubits may be physically implemented using, for example, photons, trapped ions, electrons, one or more nuclei, superconductor circuits and/or quantum dots. In other words, a qubit may be physically implemented in a variety of means, including the polarization state of a single photon; the spatial optical path of a single photon; two differing energy states of an atom or an ion; the spin orientation of a particle or plurality of particles such as a nucleus. The quantum computer also comprises means for storing the qubits and maintaining the qubits in a suitable environment to allow quantum computation, for example means for supercooling the qubits. The qubits may be operated upon by one or more quantum circuits, formed by a suitable arrangement of quantum gates.

A quantum gate acts on some number of qubits and can be thought of as the quantum analogue of a basic low-level instruction in a classical circuit such as a NOT or AND gate. Typically, quantum circuits are decomposed into a sequence of single and two-qubit gates taken from a universal gate set along with state preparation and the measurement or read-out of the qubits. However, it is also possible to construct quantum circuits using quantum gates that act on more than two qubits, i.e. ‘multi-qubit’ gates. The results of the measurements are classical data that are then processed by a classical computer. Many quantum computers based on superconducting circuits and trapped-ions have already demonstrated all of the capabilities at a small scale that are required for a large quantum computing device.

Possible implementations and methods of manipulation of the qubits in the quantum computer are now described. These implementations are by way of example only, and the skilled person will be aware of other methods of implementing a quantum computer. Birefringent wave plates may be used to manipulate the polarization state of a single photon, for example, to cause a linear polarization or horizontal polarization of the photon, signifying two distinct states of the photon. The qubits may also be implemented using a beam splitter. For example, the presence or absence of a photon along a particular optical path can be implemented using a beam splitter that splits a beam of photons into two separate paths. The presence of the photon in either path represents two distinct states of the photon. Alternatively or additionally, two separate electronic energy states for an atom or ion can represent two separate distinct states for a qubit. For example, transition energies between these levels may correspond to the energy of electromagnetic radiation of a certain frequency and so the separate energy states of the atom or ion may be addressed using a source of radiation such as a laser or microwave emitter. Alternatively or additionally, the two distinct spin states (spin “up” and spin “down”) of a particle or a plurality of particles, for example a nucleus, can represent the two distinct states of a qubit. Manipulations of nuclear spin may be implemented using a magnetic field using methods known to the person skilled in the art.

Alternatively or additionally, superconducting electronic circuits may be used to create qubits. These systems are supercooled to below 100K and use Josephson junctions, a non-linear inductor that allows the creation of anharmonic oscillators. Anharmonic oscillators do not have evenly spaced energy levels (unlike harmonic oscillators) and therefore two of the states can be separately controlled, and used to store a qubit. The qubits are connected with microwave cavities and single and two-qubit gates can be performed using microwave signals.

The quantum computing device 1110 also comprises measurement means 1104 and control means 1106. The control means 1106 may comprise control hardware and/or a control device. The control means 1106 is configured to receive instructions from the classical computer 1150, and the classical computer 1150 may instruct the control means 1106 to prepare a particular state in the quantum processor using a particular arrangement of quantum gates. Additionally, the control means may be configured to receive instructions to construct quantum circuits at the quantum processor. The measurement means 1104 may comprise measurement hardware and/or a measurement device. The measurement means comprises hardware configured to take a measurement from a state prepared by the control means 1106 in the quantum processor 1102.

The example classical computing device 1150 includes a processor 1152, a main memory 1154 (e.g., read-only memory (ROM), flash memory, dynamic random access memory (DRAM) such as synchronous DRAM (SDRAM) or Rambus DRAM (RDRAM), etc.), a static memory 1156 (e.g., flash memory, static random access memory (SRAM), etc.), and a secondary memory (e.g., a data storage device), which communicate with each other via a bus.

Processing device 1152 represents one or more general-purpose processors such as a microprocessor, central processing unit, or the like. More particularly, the processing device 1152 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1152 may also be one or more special-purpose processing devices such as an application specific integrated circuit (ASIC), a field programmable gate array (FPGA), a digital signal processor (DSP), network processor, or the like. Processing device 1152 is configured to execute the processing logic for performing the operations and steps discussed herein.

The data storage device may include one or more machine-readable storage media (or more specifically one or more non-transitory computer-readable storage media) on which is stored one or more sets of instructions embodying any one or more of the methodologies or functions described herein. The instructions may also reside, completely or at least partially, within the main memory 1154 and/or within the processing device 1152 during execution thereof by the computer system, the main memory 1154 and the processing device 1152 also constituting computer-readable storage media.

In general, the classical computer 1150 instructs the control means 1106 of the quantum computer 1110 to prepare a particular state in the quantum processor 1102. The control means 1106 manipulates the qubits in the quantum processor 1102 based on the instructions. Once the qubits have been manipulated such that the desired state has been constructed in the quantum processor 1102, the measurement means 1104 takes a measurement from the state. The quantum computer 1110 then communicates the measurement result to the classical computer.

The various methods described herein may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “comparing”, “enabling”, “maintaining,” “identifying,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference is made herein to an energy level of a physical system. The physical system could be any of an atom, a molecule, a collection of atoms, enzyme or part thereof, or material such as a potential superconductor. In addition, many other problems can be solved by mapping to a Hamiltonian and solving by finding an energy level such as the ground state. For example, optimisation problems as diverse as scheduling tasks or searching for faults in a circuit can be effectively solved by this method. As will be understood by the skilled person, an energy level of a physical system refers to the eigenvalues of the corresponding Hamiltonian.

To give an example of the many industrial applications of the present method, the search for a more efficient means of producing fertiliser is an example of a technological problem which could be aided by better understanding of reactant energy levels. The production of ammonia via the Haber-Bosch process is crucial for fertiliser production, but requires both high pressure and high temperatures and as a result is a very energy intensive process. Nitrogenase, in contrast, is an enzyme that achieves the same task at room temperature and at standard pressure, and there is therefore intense interest in understanding the nitrogenase enzyme. It is known that greater knowledge of the energy levels of the iron-molybdenum cofactor (FeMo-co) within the MoFe protein contained in the Nitrogenase enzyme would lead to significant advances in the discovery of a more efficient method for producing ammonia.

The approaches described herein may be embodied on a computer-readable medium, which may be a non-transitory computer-readable medium. The computer-readable medium carrying computer-readable instructions arranged for execution upon a processor so as to make the processor carry out any or all of the methods described herein.

The term “computer-readable medium” as used herein refers to any medium that stores data and/or instructions for causing a processor to operate in a specific manner. Such storage medium may comprise non-volatile media and/or volatile media. Non-volatile media may include, for example, optical or magnetic disks. Volatile media may include dynamic memory. Exemplary forms of storage medium include, a floppy disk, a flexible disk, a hard disk, a solid state drive, a magnetic tape, or any other magnetic data storage medium, a CD-ROM, any other optical data storage medium, any physical medium with one or more patterns of holes, a RAM, a PROM, an EPROM, a FLASH-EPROM, NVRAM, and any other memory chip or cartridge.

It will be understood that the above description of specific embodiments is by way of example only and is not intended to limit the scope of the present disclosure. Many modifications of the described embodiments are envisaged and intended to be within the scope of the present disclosure.

The above implementations have been described by way of example only, and the described implementations and arrangements are to be considered in all respects only as illustrative and not restrictive. It will be appreciated that variations of the described implementations and arrangements may be made without departing from the scope of the invention.

1. A computer-implemented method for enabling determination of a measurement value for each operator of a plurality of operators, the method comprising:
grouping the plurality of operators into one or more sets of mutually commuting operators, each set comprising one or more of the plurality of operators;
determining, for each set of operators:
a subset of transformed operators based on the set of operators, such that the set of operators are equal to products of the subset of transformed operators;
a mapping circuit based on the subset of transformed operators, wherein the mapping circuit comprises an arrangement of quantum gates configured to operate on a plurality of qubits in a quantum computer, and
a post-measurement processing routine, based on the subset of transformed operators, for transforming qubit measurement values into operator measurement values for each of the operators in the set of operators.

2. The method of claim 1, further comprising performing a measurement routine for each set of operators, the measurement routine comprising:
preparing, using the plurality of qubits in the quantum computer, a trial state using a first arrangement of quantum gates;
operating the mapping circuit on the plurality of qubits in the trial state;
performing a measurement on each qubit of the plurality of qubits, to obtain a qubit measurement value for each qubit; and
applying the post-measurement processing routine to the qubit measurement values to transform the qubit measurement values into the operator measurement values for each of the operators in the set of operators.

3. The method of claim 2, wherein the method is configured to estimate an energy level of a physical system using the quantum computer, and wherein the energy level is described by summation of expectation values of the plurality of operators, the method further comprising determining the estimate of the energy level of the physical system based on at least the determined operator measurement values for each operator in each set.

4. The method of claim 2, wherein determining the subset of transformed operators, determining the mapping circuit, and determining the post-measurement processing routine is carried out using a classical computer, and wherein the classical computer further carries out the step of applying the post-measurement processing routine to the qubit measurement values to transform the qubit measurement values into operator measurement values for each of the operators in the set of operators.

5. The method of claim 2, wherein preparing the trial state, operating the mapping circuit, and performing a measurement on each qubit is carried out using the quantum computer.

6. The method of claim 2, wherein the measurement routine is performed a plurality of times for each set to obtain a corresponding plurality of operator measurement values for each operator in each set, the method further comprising determining an expectation value of each operator in each set based on an average of the corresponding plurality of operator measurement values.

7. The method of claim 6, wherein determining the estimate of the energy level comprises a summation of the expectation values for each operator in each set.

8. The method of claim 1, wherein the mapping circuit comprises at least one multi-qubit gate configured to act on at least two of the plurality of qubits.

9. The method of claim 8, wherein the mapping circuit comprises one or more multi-qubit gates, wherein the number of multi-qubit gates is proportional to the number of the plurality of qubits, and wherein the proportionality has an upper bound of the number of the plurality of qubits multiplied by the number of independent operators in the set of operators, wherein each operator in the set of operators can be constructed from the one or more independent operators.

10. The method of claim 1, wherein the mapping circuit comprises one or more single-qubit gates configured to apply rotations to each qubit of the plurality of qubits.

11. The method of claim 1, wherein determining a subset of transformed operators comprises:
determining one or more independent operators of the set of operators, wherein each operator in the set of operators can be constructed from the one or more independent operators; and
transforming the one or more independent operators into the subset of transformed operators.

12. The method of claim 11, wherein transforming the one or more independent operators into the subset of transformed operators comprises:
determining whether the number of independent operators matches the number of the plurality of qubits; and
responsive to determining that the number of independent operators is less than the number of the plurality of qubits:
constructing one or more new transformed operators to be added to the subset of transformed operators, such that the number of transformed operators matches the number of qubits.

13. The method of claim 1, wherein the qubit measurements represent measurements of the subset of transformed operators.

14. A computer readable medium comprising instructions which, when executed by a processor, cause the processor to perform the method of claim 1.

15. An apparatus comprising a classical computer and a quantum computer configured to carry out the method of claim 1.
